(19) United States
(12) Patent Application Publication
(10) Pub. No.: US 2016/0073098 A1
(43) Pub. Date: Mar. 10, 2016

(54) HEAD-UP DISPLAY SYSTEM USING AUTO-STEREOSCOPY 3D TRANSPARENT ELECTRONIC DISPLAY

(71) Applicant: Continental Automotive Systems, Inc., Auburn Hills, MI (US)

(72) Inventors: Luis Alfredo Villalobos Martinez, Tlaquepaque (MX); Luis Fernando Espitia Orozco, Guadalajara (MX)

(21) Appl. No.: 14/482,639

(22) Filed: Sep. 10, 2014

(51) Int. Cl. H04N 13/04; G06K 9/00; G02B 27/01

(52) U.S. Cl. CPC H04N 13/0409; G02B 27/0101; G06K 9/00791

(57) ABSTRACT

A head up display system for a vehicle includes a vehicle network constructed and arranged to receive vehicle operating data. A system controller, based on the operating data, receives a request signal from the vehicle network regarding information to be displayed. A graphics controller is constructed and arranged to process images, using a three-dimensional auto-stereoscopic effect, of the information to be displayed. A transparent display is visually associated with a transparent windshield of the vehicle in a line of sight of the driver so that the driver can view a road through both the windshield and the transparent display. Based on a signal received from the graphics controller, the transparent display is constructed and arranged to display the images to the driver at the line of sight in a three-dimensional auto-stereoscopic manner, without the need for the driver to wear three-dimension viewing eyewear.

### FIELD

The invention relates to a display system for displaying information to a driver of a vehicle and, more particularly, to a head-up display system using an auto-stereoscopy three-dimensional (3D) transparent display.

### BACKGROUND

Conventional head-up displays (HUD) for vehicles provide information to a driver of the vehicle generally at a driver's eye level so as that the driver can maintain eye focus on the road while viewing the display. These systems are useful, however, due to the use of projection (e.g., digital micromirror device (DMD), thin film transistor (TFT), laser), these systems are complex in terms of electrical and mechanical engineering.

Thus, there is a need to provide a HUD system for a vehicle that uses an auto-stereoscopy transparent electronic display creating a three-dimensional visual effect for the driver and that removes the optical complications of projection.

### SUMMARY

An objective of the invention is to fulfill the need referred to above. In accordance with the principles of an embodiment, this objective is obtained by providing a head up display system for a vehicle that includes a vehicle network constructed and arranged to receive vehicle operating data. A system controller is associated with the vehicle network and is constructed arranged, based on the operating data, to receive a request signal from the vehicle network regarding information to be displayed. A graphics controller is associated with the system controller and is constructed and arranged to process images, using a three-dimensional auto-stereoscopic effect, of the information to be displayed. A transparent display is constructed and arranged to be visually associated with a transparent windshield of the vehicle in a line of sight of the driver so that the driver can view a road through both the windshield and the transparent display. Based on a signal received from the graphics controller, the transparent display is constructed and arranged to display the images to the driver at the line of sight in a three-dimensional auto-stereoscopic manner, without the need for the driver to wear three-dimension viewing eyewear.

In accordance with another aspect of an embodiment, a method provides a head up display for a vehicle. The method receives vehicle operating information, generates images based on the received vehicle operating information, and displays the images, via a transparent display that is visually associated with a transparent windshield of the vehicle, to the driver at a line of sight of the driver and in a three-dimensional auto-stereoscopic manner, without the need for the driver to wear three-dimension viewing eyewear.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is block diagram of 3D auto-stereoscopic HUD system having a transparent electronics display in accordance with an embodiment.

FIG. 2 is a view the transparent electronics display of the system of FIG. 1, shown associated with a windshield of a vehicle.

### DETAILED DESCRIPTION OF EXEMPLARY EMBODIMENTS

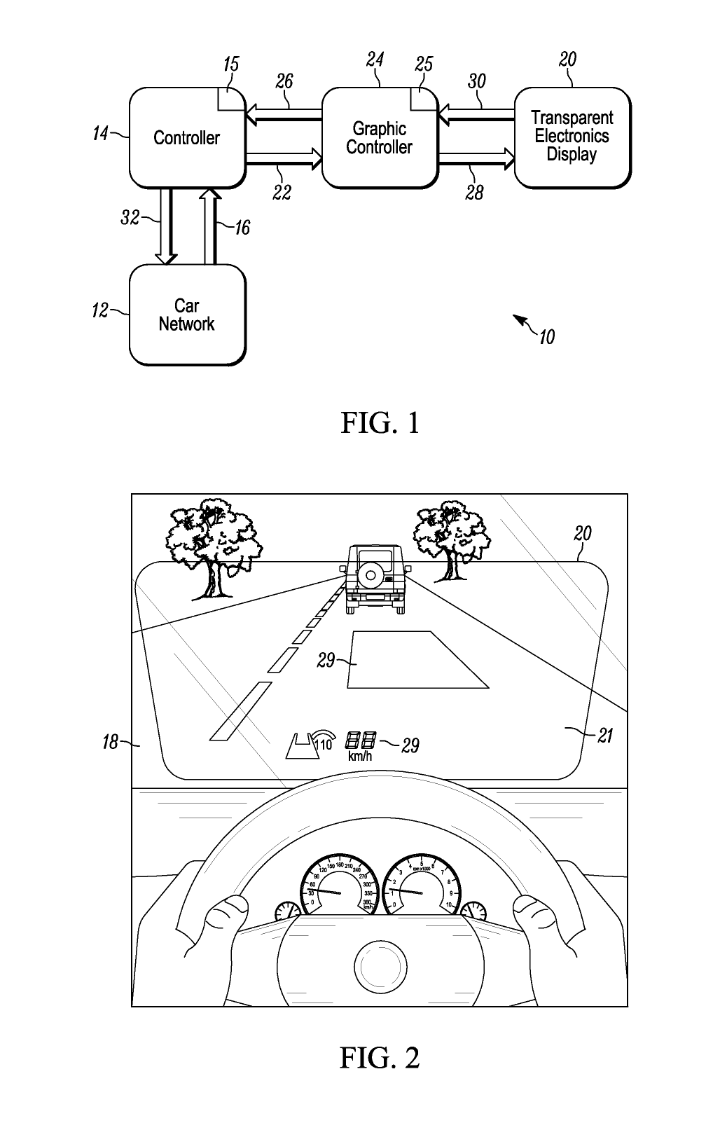

With reference to FIG. 1, a block diagram of a 3D auto-stereoscopic HUD system is shown, generally indicated at 10, in accordance with an embodiment. The system 10 is preferably for use in vehicles such as passenger cars and includes a vehicle (e.g., car) network 12 that receives vehicle operating data and that communicates through any automotive communication protocol (CAN, Ethernet, LVDS, etc.) directly to a system controller 14. Based on the operating data, the car network 12 sends a first request signal 16 to the system controller 14 regarding information to be displayed on a transparent windshield 18 (FIG. 2) of the vehicle using a transparent electronics display 20 associated with the windshield 18. The request signal 16 can be triggered by the vehicle's driver or by the car itself. The display 20 can be embedded into the windshield 18 (e.g., between glass sheets), or can be mounted adjacent to an interior portion of the windshield 18 (e.g., behind the steering wheel) in a line of sight of the driver so that the driver can see through both the display 20 and the windshield 18 to view the road ahead (FIG. 2).

The controller 14 includes a processor 15 and sends a second request signal 22 to a graphics controller 24. The graphics controller 24 has a processor 25 to process and generate images of the information to be displayed. The graphics controller 24 provides a continuous image processing status signal 26 back to the controller 22 regarding this process. The graphics controller 24 also controls and applies a 3D auto-stereoscopic effect, such as by using a transparent parallax barrier 21 on the transparent electronics display 20. The parallax barrier 3D effect is of the type that does not require the driver to wear any special three-dimension viewing eyewear, and can be of the type disclosed in U.S. Pat. No. 8,102,413, the content of which is hereby incorporated by reference into this specification. The display 20 receives the image information from the graphics controller 24 via request signal 28 and, with reference to FIG. 2, creates the 3D effect (e.g., using parallax barrier 21) of the images 29 for the vehicle's driver. The display 20 provides a feedback signal 30, regarding the 3D effect image status of the information being displayed, to the graphics controller 24. It can be appreciated that the graphics controller 24 can be part of the system controller 14 if desired.

As shown in FIG. 2, the transparent electronics display 20 shows the images 29 based on the information requested by the driver or the car network with a 3D effect (preferably generated by the parallax barrier technique), making the images 29 appear to be visible outside of the windshield 18 at the driver's sight level. The images 29, such as a distance indication to the vehicle ahead, a current speed of the driven vehicle, etc., are displayed in a way that the driver is always focusing his/her sight on the road ahead, due the 3D effect of the images that are being shown at the road level. The controller 14 also sends a displayed information status signal 32, regarding the displayed images 29, back to the car network 12.

Thus, it can be appreciated that the system 10 provides an improved HUD system for a vehicle that uses an auto-stereoscopy transparent electronic display creating a three-dimensional visual effect of images 29 for the driver. The system 10 has low power consumption and also removes the optical complications of projection such as mirrors, light source, light direction, space in the car cockpit, and assembly.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A head up display system for a vehicle, comprising:
a vehicle network constructed and arranged to receive vehicle operating data,
a system controller associated with the vehicle network and constructed arranged, based on the operating data, to receive a request signal from the vehicle network regarding information to be displayed,
a graphics controller associated with the system controller and constructed and arranged to process images, using a three-dimensional auto-stereoscopic effect, of the information to be displayed, and
a transparent display constructed and arranged to be visually associated with a transparent windshield of the vehicle in a line of sight of the driver so that the driver can view a road through both the windshield and the transparent display,
wherein, based on a signal received from the graphics controller, the transparent display is constructed and arranged to display the images to the driver at the line of sight in a three-dimensional auto-stereoscopic manner, without the need for the driver to wear three-dimension viewing eyewear.

2. The head up display of claim 1, in combination with the vehicle, wherein the transparent display is embedded in the windshield and is constructed and arranged to display the images to appear to the driver as being outside of the windshield.

3. The head up display of claim 1, in combination with the vehicle, wherein the transparent display is mounted adjacent to an interior portion of the windshield and is constructed and arranged to display the images to appear to the driver as being outside of the windshield.

4. The head up display of claim 1, wherein the transparent display includes a transparent parallax barrier constructed and arranged to cause the images displayed to appear to the driver as being outside of the windshield.

5. The head up display of claim 1, wherein the transparent display is constructed and arranged to provide an image status signal back to the graphics controller, the graphics controller is constructed and arranged to provide an image processing status signal back to the system controller and the system controller is constructed and arranged to provide a displayed information status signal back to the vehicle network.

6. A method of providing a head up display for a vehicle, the method comprising the steps of:
receiving vehicle operating information,
generating images based on the received vehicle operating information, and
displaying the images, via a transparent display that is visually associated with a transparent windshield of the vehicle, to the driver at a line of sight of the driver and in a three-dimensional auto-stereoscopic manner, without the need for the driver to wear three-dimension viewing eyewear.

7. The method of claim 6, further comprising embedding the transparent display in the windshield.

8. The method of claim 6, further comprising mounted the transparent display adjacent to an interior portion of the windshield.

9. The method of claim 6, wherein the displaying step includes using a transparent parallax barrier on the transparent display.

10. The method of claim 6, wherein the generating step includes using a processor of a graphics controller to generate the images, the graphics controller being associated with the transparent display.

11. The method of claim 6, wherein the receiving step includes using a vehicle network to receive the vehicle operating information, the method further comprising:
based on the vehicle operating data, receiving at a system controller, a request signal from the vehicle network, with the system controller sending a signal to a graphics controller to initiate the generating step, the graphics controller being associated with the transparent display.

12. The method of claim 11, further comprising sending a feedback signal, regarding the status of the images being displayed, to the vehicle network.

13. The method of claim 6, wherein the displaying step includes displaying the images to appear to the driver as being outside of the windshield.

14. The method of claim 9, wherein the displaying step includes displaying the images to appear to the driver as being outside of the windshield.
